(19) United States
(12) Patent Application Publication
(10) Pub. No.: US 2026/0097814 A1
(43) Pub. Date: Apr. 9, 2026

(54) REAR FACING SEAT FOR GOLF VEHICLES

(71) Applicant: Textron Inc., Providence, RI (US)

(72) Inventors: Roger Dale Rhinehart,, JR., N. Charleston, SC (US); Samuel Smith, Augusta, GA (US); Jordan Mark Red, North Augusta, SC (US); Michael Andrew Duvall, Grovetown, GA (US); Matthew Joseph Baekelandt, North Augusta, SC (US)

(73) Assignee: Textron Inc., Providence, RI (US)

(21) Appl. No.: 18/910,302

(22) Filed: Oct. 9, 2024

(51) Int. Cl. B62D 25/20; B60N 2/36; B60N 2/68; B60N 2/75; B60N 3/06

(52) U.S. Cl. CPC B62D 25/2027; B60N 2/36; B60N 2/68; B60N 2/75; B60N 3/06

(57) ABSTRACT

A golf vehicle includes a vehicle frame, an adapter assembly coupled to the vehicle frame, a floorboard assembly, and a pin. The adapter assembly includes an adapter bracket defining a first aperture and a tube coupled to the adapter bracket. The floorboard assembly includes a floorboard frame removably coupled to the adapter assembly. The floorboard frame includes a first frame rail defining a second aperture positioned to align with the first aperture and a second frame rail selectively received by the tube. The pin selectively insertable through the first aperture and the second aperture such that, when the pin is positioned through the first aperture and the second aperture, the floorboard assembly is secured to the adapter bracket.

### BACKGROUND

Golf vehicles are used to transport personnel and equipment between different areas. By way of example, a golf vehicle may transport golfers and equipment (e.g., golf bags, golf clubs, etc.) around a golf course (e.g., along a cart path, between different holes, etc.). When transporting golfers, a golf vehicle may include a seat for an operator or driver and one or more seats for passengers.

### SUMMARY

One embodiment relates to a golf vehicle. The golf vehicle includes a vehicle frame, an adapter assembly, a floorboard assembly, and a pin. The adapter assembly is coupled to the vehicle frame. The adapter assembly includes an adapter bracket defining a first aperture and a tube coupled to the adapter bracket. The floorboard assembly includes a floorboard frame removably coupled to the adapter assembly. The floorboard frame includes a first frame rail defining a second aperture positioned to align with the first aperture and a second frame rail selectively received by the tube. The pin is selectively insertable through the first aperture and the second aperture such that, when the pin is positioned through the first aperture and the second aperture, the floorboard assembly is secured to the adapter bracket.

Another embodiment relates to a golf vehicle. The golf vehicle includes a vehicle frame, a bumper, an adapter assembly, and a seat assembly. The bumper is coupled to the vehicle frame. The adapter assembly is coupled to the vehicle frame and positioned below the bumper. The adapter assembly includes an adapter bracket. The seat assembly is positioned above the bumper. The seat assembly includes a seat frame, a support, and a seat body. The support is coupled to the adapter assembly and is positioned forward from the bumper. The seat body is pivotably coupled to the seat frame and is configured to rotate relative to the seat frame about an axis of rotation that extends laterally.

Still another embodiment relates to a rear-facing seat assembly for a golf vehicle. The rear-facing seat assembly includes an adapter assembly, a floorboard assembly, a pin, a seat frame, a seat body, and a support. The adapter assembly includes an adapter bracket defining a first aperture. The floorboard assembly includes a floorboard frame having a frame rail defining a second aperture positioned to align with the first aperture. The pin is selectively insertable through the first aperture and the second aperture such that, when the pin is positioned through the first aperture and the second aperture, the floorboard assembly is secured to the adapter assembly. The seat frame is positioned above the adapter assembly. The seat body is coupled to the seat frame. The support extends between the adapter assembly and the seat frame to at least partially support the seat frame.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a rear perspective view showing a portion of the vehicle of FIG. 1 including a rear-facing seat assembly, according to an exemplary embodiment.

FIG. 4 is a rear perspective view showing a portion of the vehicle of FIG. 3 including the rear-facing seat assembly, according to an exemplary embodiment.

FIG. 5 is a rear perspective view showing a portion of the vehicle of FIG. 3 including the rear-facing seat assembly, according to an exemplary embodiment.

FIG. 6 is another rear perspective view showing a portion of the vehicle of FIG. 3 without the rear-facing seat assembly, according to an exemplary embodiment.

FIG. 7 is a rear perspective view showing a portion of the vehicle of FIG. 3 with a portion of the rear-facing seat assembly, according to an exemplary embodiment.

FIG. 8 is a rear perspective view showing a portion of the vehicle of FIG. 3 with the rear-facing seat assembly shown in a partially disassembled state, according to an exemplary embodiment.

FIG. 9 is a perspective view showing a portion of the rear-facing seat assembly of FIG. 3 shown in a disassembled state, according to an exemplary embodiment.

FIG. 10 is a perspective view showing a bushing usable in the rear-facing seat assembly of FIG. 3, according to an exemplary embodiment.

FIG. 11 is a perspective view showing the rear-facing seat assembly of FIG. 3 shown in a seating configuration, according to an exemplary embodiment.

FIG. 12 is a perspective view showing the rear-facing seat assembly of FIG. 3 shown in a cargo storage configuration, according to an exemplary embodiment.

FIG. 13 is a rear perspective view showing a portion of the rear-facing seat assembly of FIG. 3 including a guard and shown in a seating configuration, according to an exemplary embodiment.

FIG. 14 is a rear perspective view showing a portion of the rear-facing seat assembly of FIG. 13 including the guard and shown in a cargo storage configuration, according to an exemplary embodiment.

FIG. 15 is a side perspective view showing a portion of the vehicle of FIG. 3 including the rear-facing seat assembly of FIG. 13 with the guard, according to an exemplary embodiment.

FIG. 16 is a side view showing a portion of the vehicle including the rear-facing seat assembly with the guard of FIG. 15, according to an exemplary embodiment.

FIG. 17 is a rear perspective view showing a portion of the vehicle including the rear-facing seat assembly with the guard of FIG. 15, shown in a partially disassembled state, according to an exemplary embodiment.

FIG. 18 is a perspective view showing the rear-facing seat of FIG. 13 shown in a floorboard storage configuration, according to an exemplary embodiment.

FIG. 19 is a rear perspective view showing a guard usable with the rear-facing seat assembly of FIG. 13, according to an exemplary embodiment.

FIG. 20 is a rear perspective view showing the guard of FIG. 19, shown in a disassembled state, according to an exemplary embodiment.

FIG. 21 is a rear perspective view showing a portion of the rear-facing seat assembly of FIG. 13 with a guard shown with a seat body in a cargo storage configuration and the guard in a first guard configuration, according to an exemplary embodiment.

FIG. 22 is a rear perspective view showing a portion of the rear-facing seat assembly of FIG. 21 with the seat body in a cargo storage configuration and the guard in a second guard configuration, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

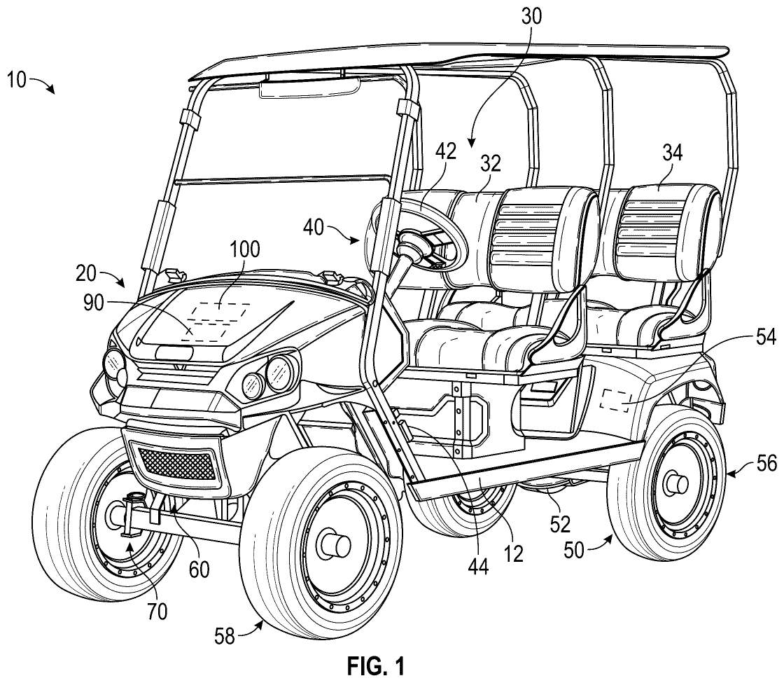

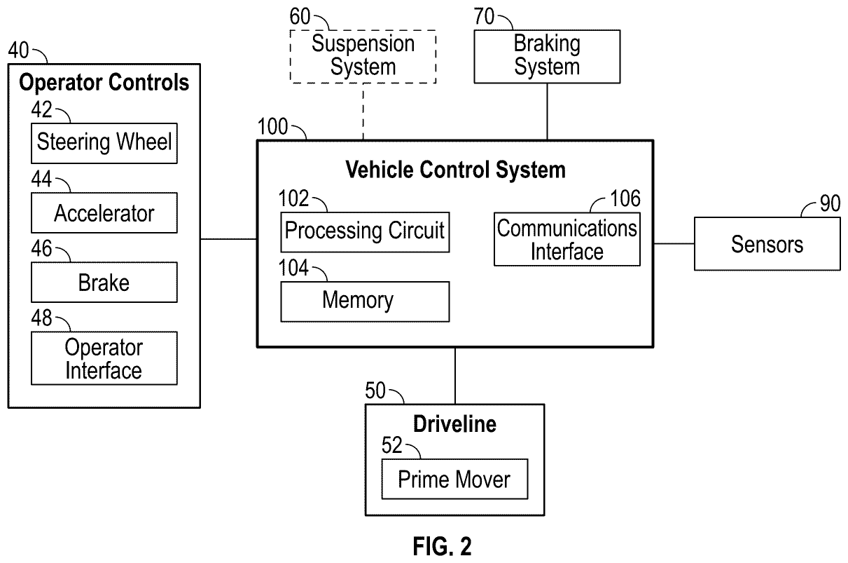

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system.

In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Vehicle Structure

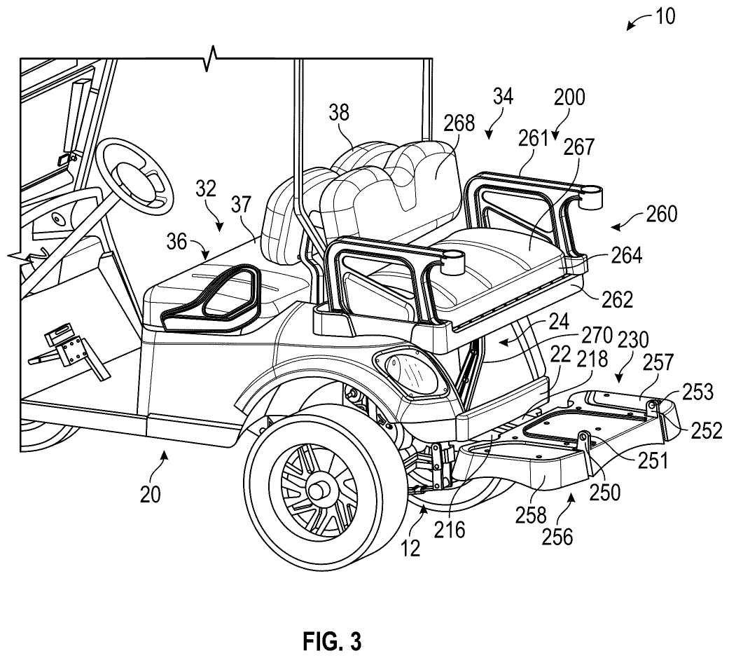

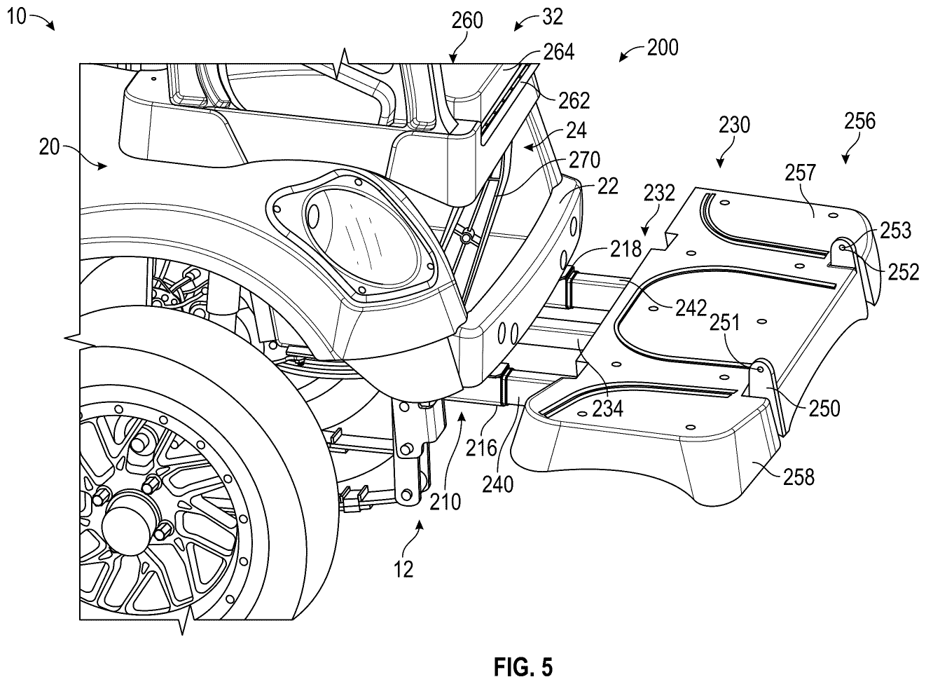

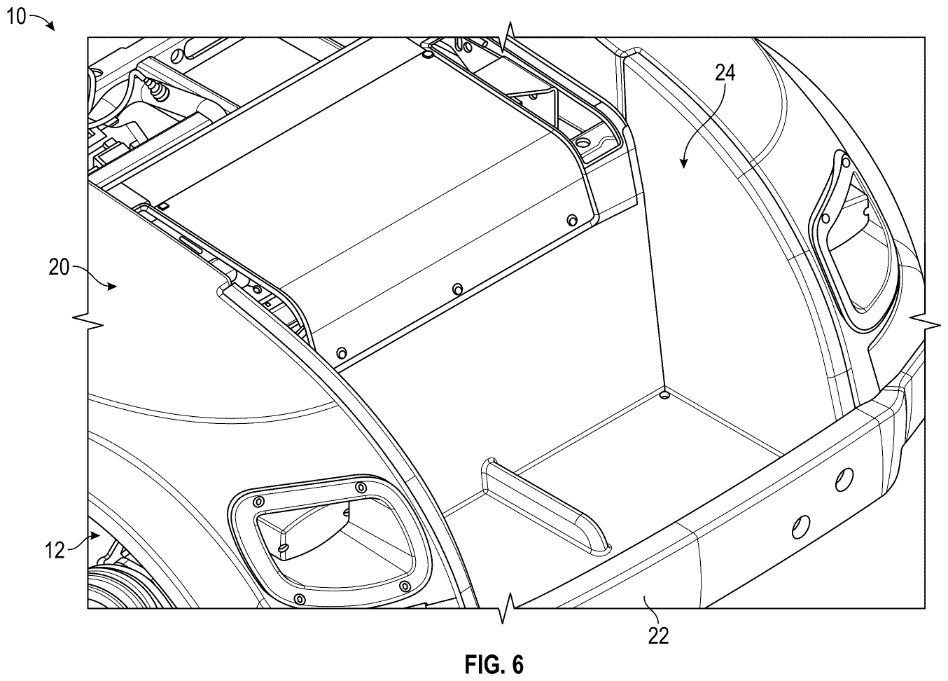

Referring to FIGS. 3-8, the vehicle 10 is shown according to various exemplary embodiments. The vehicle 10 of FIGS. 3-8 may be substantially similar to the vehicle 10 of FIG. 1 except as otherwise specified herein. In some embodiments, the vehicle 10 is configured as a golf vehicle.

As shown in FIG. 3, the vehicle 10 includes the front row seating 32 and the rear row seating 34. The front row seating 32 is facing forward, and the rear row seating 34 is facing rearward. The front row seating 32 is provided as part of a first seat assembly, shown as front-facing seat assembly 36. The front-facing seat assembly 36 is coupled to the frame 12 and extends laterally across the body 20, from a right side of the body 20 (e.g., a first lateral side) to a left side of the body 20 (e.g., a second lateral side). Accordingly, the front-facing seat assembly 36 may provide at least two seats (e.g., for an operator or driver and one or more passengers). As shown in FIG. 3, the front-facing seat assembly 36 includes a first seat portion, shown as seat body 37 (e.g., a first seat body, a forward-facing seat body, a seat bottom, etc.), and a second seat portion, shown as backrest 38 (e.g., a first backrest, forward-facing backrest, etc.). The seat body 37 extends substantially horizontally and supports the bottom of one or more occupants. The backrest 38 extends substantially vertically and supports the back of the one or more occupants.

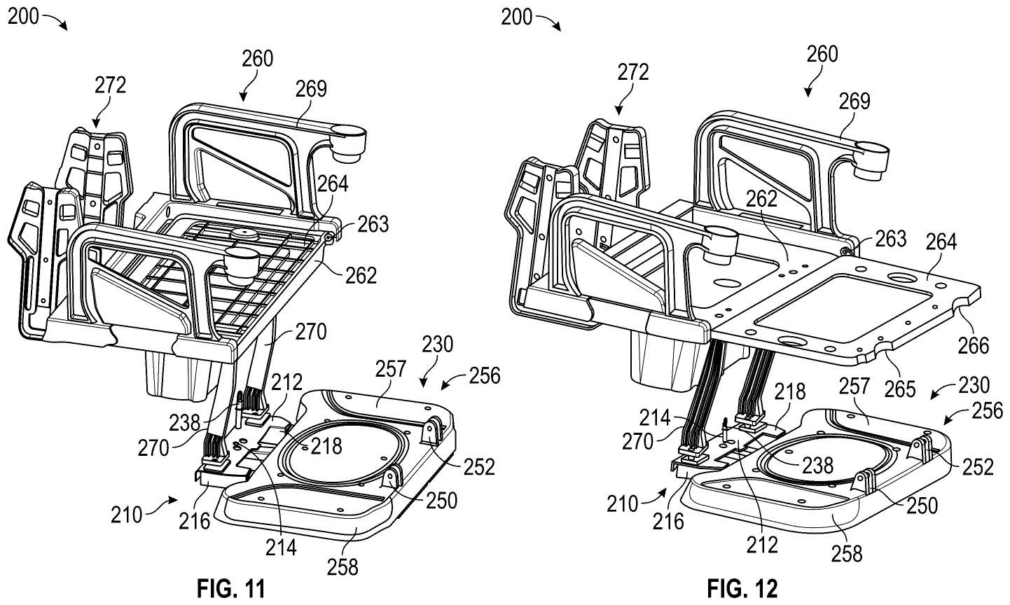

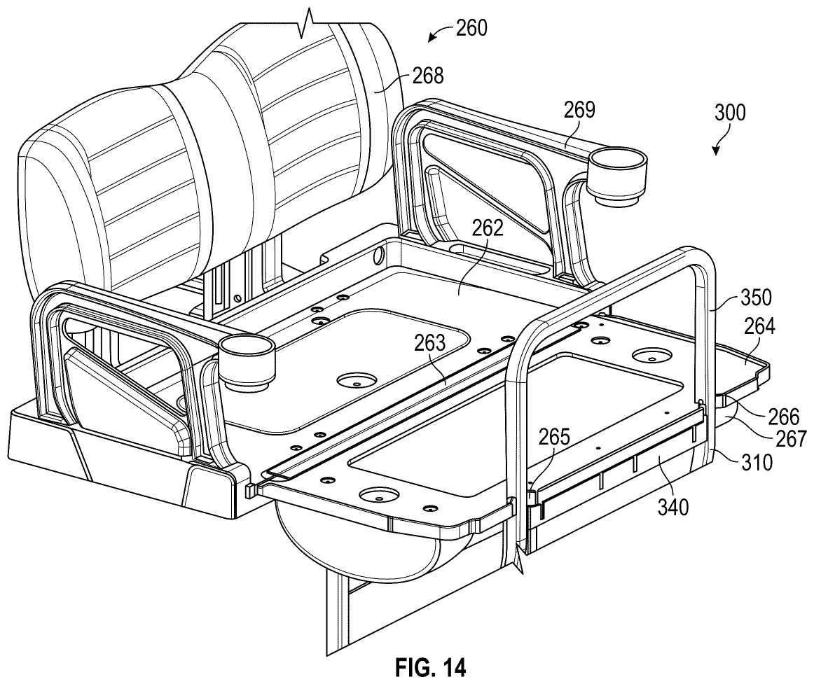

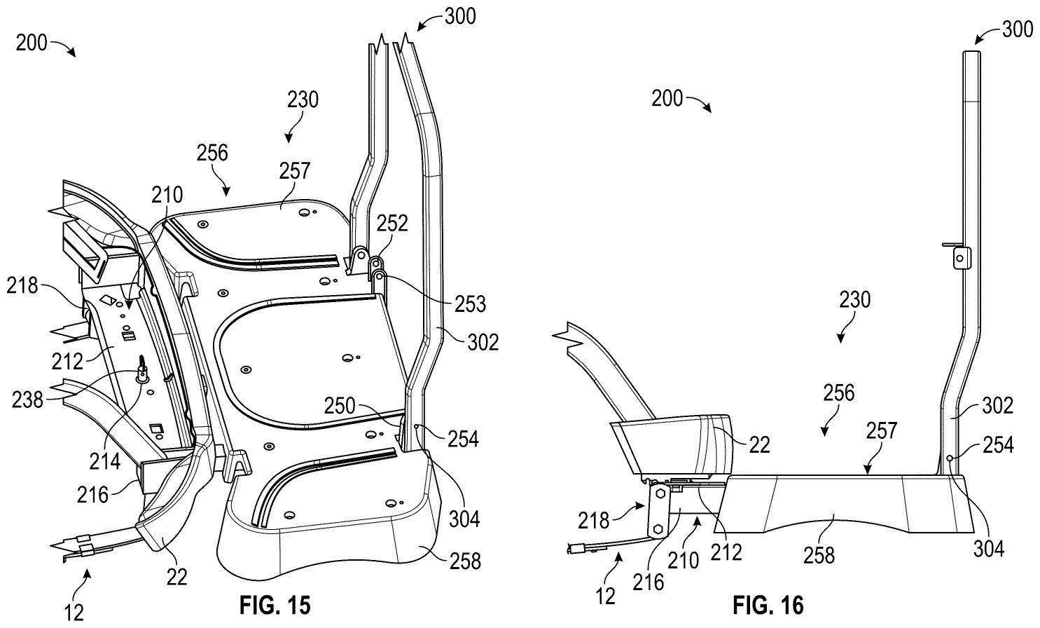

The rear row seating 34 is provided as part of a second seat assembly, shown as rear-facing seat assembly 200 in FIGS. 3-5, 7 and 8. The rear-facing seat assembly 200 is shown with a portion of the vehicle 10 in FIGS. 15-17. The rear-facing seat assembly 200 is also shown without the vehicle 10 in FIGS. 11-14 and 18. The structure of the rear-facing seat assembly 200 is described in greater detail below.

As shown in FIGS. 3-8, the vehicle 10 includes a rear body portion, shown as bumper 22. As shown in FIGS. 3-8, 16, and 17, the bumper 22 is coupled to the frame 12. As shown in FIGS. 3-8, the bumper 22 is positioned at a rear side of the body 20. The bumper 22 extends laterally across the body 20, from a right side of the body 20 (e.g., the first lateral side) to a left side of the body 20 (e.g., the second lateral side).

As shown in FIGS. 3-8, the vehicle 10 includes a storage area (e.g., for storing golf equipment), shown as equipment storage area 24. The equipment storage area 24 may be at least partially defined by the body 20. According to the exemplary embodiment shown in FIGS. 3-8, the equipment storage area 24 is positioned rearward of the front row seating 32. In particular, the equipment storage area 24 is positioned rearward of the seat body 37. As shown in FIGS. 3-5 and 8, at least a portion of the rear-facing seat assembly 200 is positioned within the equipment storage area 24.

### Rear-Facing Seat Assembly

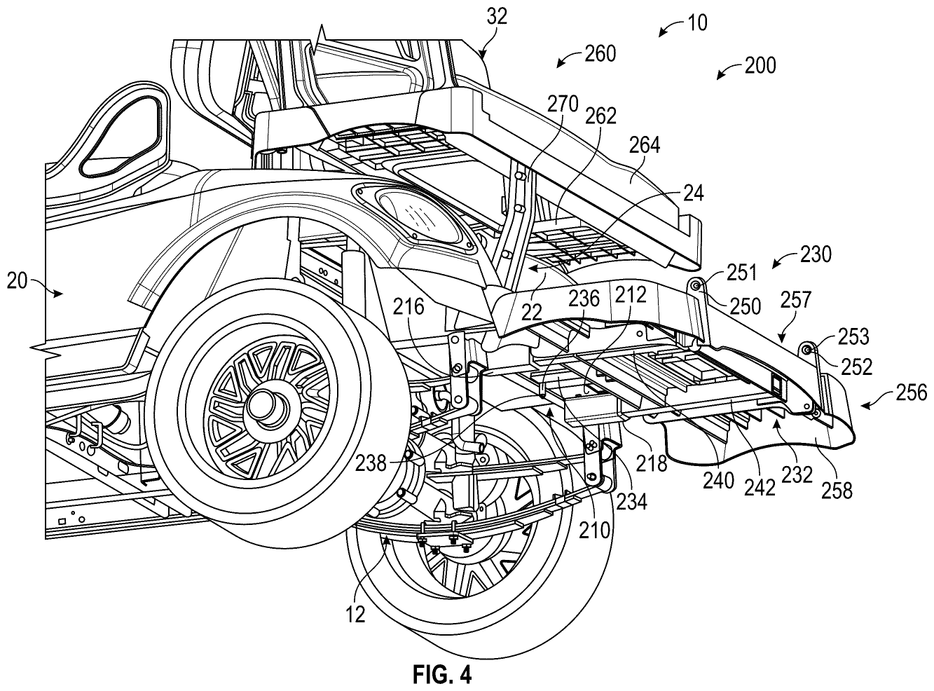

Various components of the rear-facing seat assembly 200 are shown in FIGS. 3-5 and 7-22. As shown in FIGS. 4, 5, 7-9, 11, 12, and 15-17, the rear-facing seat assembly 200 includes a first assembly (e.g., a first sub-assembly, a bracket, etc.), shown as adapter assembly 210. As shown in FIGS. 3-5, 8, 9, 11, 12, and 15-17, the rear-facing seat assembly 200 includes a second assembly (e.g., a second sub-assembly), shown as floorboard assembly 230. As shown in FIGS. 3-5, 8, 13, 14, and 18, the rear-facing seat assembly 200 includes a third assembly (e.g., a third sub-assembly), shown as seat assembly 260. As shown in FIGS. 15-17, 19, and 20-22, the rear-facing seat assembly 200 includes a barrier (e.g., a railing), shown as guard 300.

As shown in FIG. 4, the adapter assembly 210 is coupled to the frame 12, and positioned below the bumper 22, as shown in FIGS. 3, 5, 7, 8, 15, and 16. In some embodiments, at least a portion of the adapter assembly 210 extends rearward of the bumper 22.

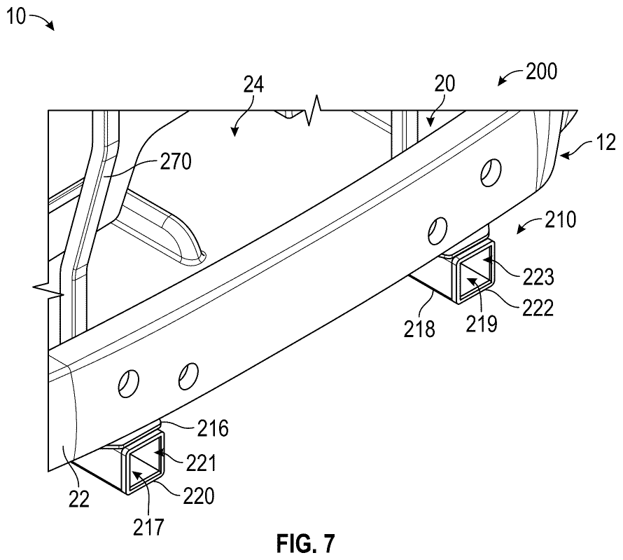

As shown in FIGS. 4, 9, 11, 12, and 15-17, the adapter assembly 210 includes a bracket (e.g., a plate, mount, etc.), shown as adapter bracket 212, and one or more tubular members, receptacles, or interfaces, shown as first tube 216 and second tube 218. As shown in FIGS. 7, 9, 10, the adapter assembly 210 includes one or more bearings (e.g., plain bearings, bushings, linear bushings, linings, etc.), shown as first bushing 220 and second bushing 222.

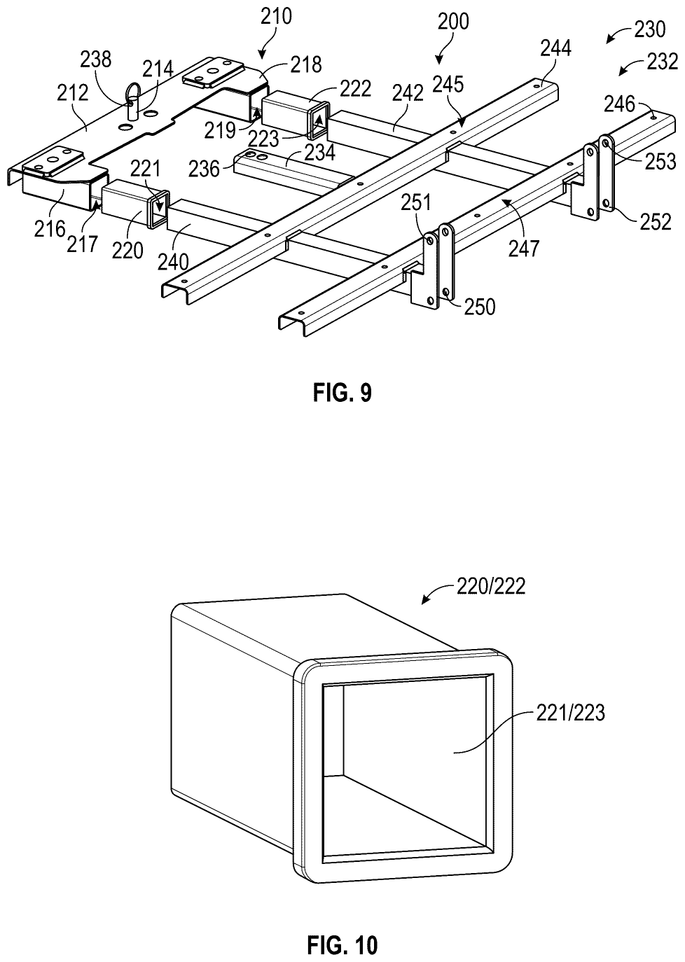

As shown in FIGS. 4, 5, 15, and 16, the adapter bracket 212 is coupled to the frame 12. More specifically, the adapter bracket 212 is fixedly coupled to the frame 12. For example, the adapter bracket 212 may be monolithically formed with the frame 12 or permanently fixed to the frame (e.g., by a welding process). As shown in FIGS. 4, 5, 15, and 16, the adapter bracket 212 is positioned below the bumper 22. As shown in FIGS. 9, 11, 12, 15, and 17, the adapter bracket 212 defines a first aperture, shown as aperture 214. The aperture 214 is positioned at or proximate a center of the adapter bracket 212 and is defined vertically through the adapter bracket 212. The aperture 214 is configured to receive a fastener, as described below. In some embodiments, the adapter bracket 212 may include or may be made from a metallic material, such as steel.

As shown in FIGS. 3-5, 7-9, 11, 12, and 15-17, the first tube 216 is coupled to the adapter bracket 212 at or proximate a first side of the adapter bracket 212 (e.g., a first lateral side of the adapter bracket 212). In some embodiments, at least a portion of the first tube 216 extends longitudinally rearward from the adapter bracket 212. According to the exemplary embodiment shown in FIGS. 3-5, 7-9, 11, 12, and 15-17, the first tube 216 has a substantially square cross section. In other embodiments, the first tube 216 has a different cross section, such as a polygonal cross section (e.g., triangular, quadrilateral, octagon, etc.) or a circular/round cross section. As shown in FIGS. 7, 9, and 17, the first tube 216 defines a first slot, shown as first tube opening 217. The first tube opening 217 is sized to receive the first bushing 220 and at least a portion of the floorboard assembly 230, as described below.

As shown in FIGS. 3-5, 7-9, 11, 12, and 15-17, the second tube 218 is coupled to the adapter bracket 212 at or proximate a second side of the adapter bracket 212 (e.g., a second lateral side of the adapter bracket 212, opposite the first lateral side), such that the second tube 218 is laterally spaced from the first tube 216. In some embodiments, at least a portion of the second tube 218 extends longitudinally rearward from the adapter bracket 212. According to the exemplary embodiment shown in FIGS. 3-5, 7-9, 11, 12, and 15-17, the second tube 218 has a substantially square cross section. In other embodiments, the second tube 218 has a different cross section, such as a polygonal cross section (e.g., triangular, quadrilateral, octagon, etc.) or a circular/round cross section. As shown in FIGS. 7, 9, and 17, the second tube 218 defines a second slot, shown as second tube opening 219. The second tube opening 219 is sized to receive the second bushing 222 and at least a portion of the floorboard assembly 230, as described below.

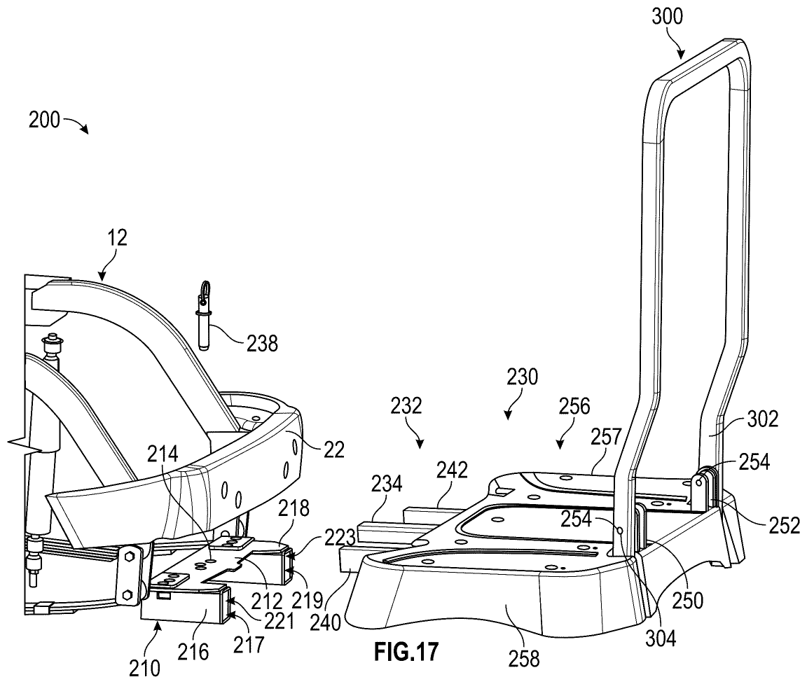

As shown in FIGS. 7 and 17, the first bushing 220 is positioned within the first tube 216. More specifically, the first tube 216 receives the first bushing 220 in the first tube opening 217. In some embodiments, the first bushing 220 is fixed to the first tube 216. For example, the first bushing 220 may be fixed to the first tube 216 in an interference fit arrangement. As shown in FIGS. 7, 9, 10, and 17, the first bushing 220 defines a third slot, shown as first bushing opening 221. The first bushing opening 221 is sized to receive at least a portion of the floorboard assembly 230, as described below. In other embodiments, the first bushing opening 221 is sized to receive another component or assembly, such as a trailer, or other rear-attachable accessory. In some embodiments, the first bushing 220 is swappable to accommodate accessories with different sized attachments that insert into the first tube 216. In some embodiments, the first bushing 220 is a linear bushing. In some embodiments, the first bushing 220 includes or is made from a plastic material, such as nylon, polytetrafluoroethylene, or another self-lubricating plastic material. In other embodiments, the first bushing 220 includes or is made from a metallic material.

As shown in FIGS. 7 and 17, the second bushing 222 is positioned within the second tube 218. More specifically, the second tube 218 receives the second bushing 222 in the second tube opening 219. In some embodiments, the second bushing 222 is fixed to the first tube 218. For example, the second bushing 222 may be fixed to the second tube 218 in an interference fit arrangement. As shown in FIGS. 7, 9, 10, and 17, the second bushing 222 defines a fourth slot, shown as second bushing opening 223. The second bushing opening 223 is sized to receive at least a portion of the floorboard assembly 230, as described below. In other embodiments, the second bushing opening 223 is sized to receive another component or assembly, such as a trailer, or other rear-attachable accessory. In some embodiments, the second bushing 222 is swappable to accommodate accessories with different sized attachments that insert into the second tube 218. In some embodiments, the second bushing 222 is a linear bushing. In some embodiments, the second bushing 222 includes or is made from a plastic material, such as nylon, polytetrafluoroethylene, or another self-lubricating plastic material. In other embodiments, the second bushing 222 includes or is made from a metallic material.

As shown in FIGS. 3-5, 8, 11, 12, 15, and 16, the floorboard assembly 230 is removably coupled to the adapter assembly 210. When the floorboard assembly 230 is coupled to the adapter assembly 210, the floorboard assembly 230 is at least partially positioned below the bumper 22. As shown in FIGS. 4, 5, 8, 9, 17, and 18, the floorboard assembly 230 includes a support structure, shown as floorboard frame 232. As shown in FIGS. 3-5, 11, 12, and 15-18, the floorboard assembly 230 includes a platform, shown as floorboard body 256.

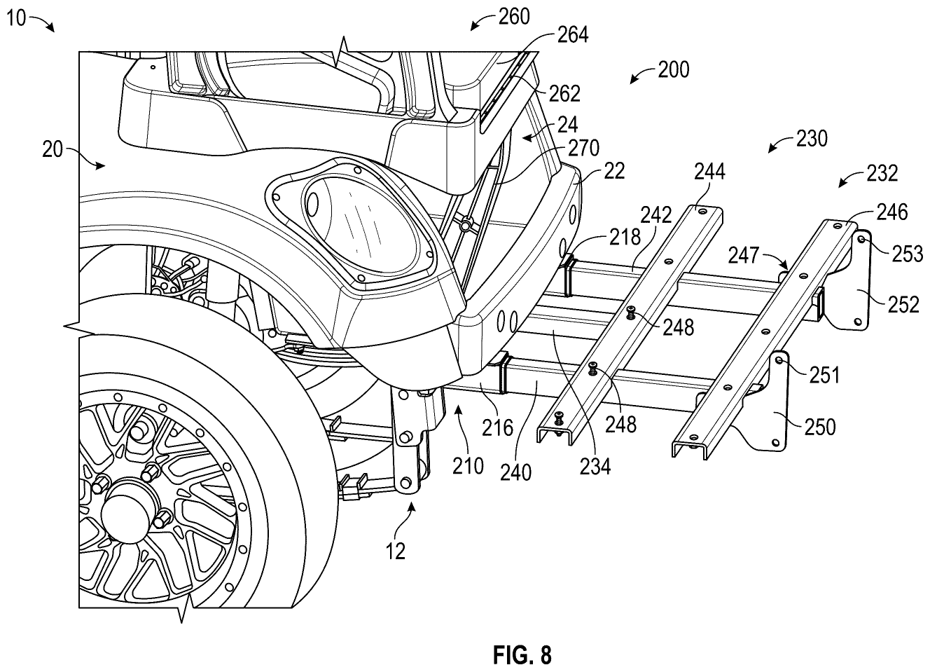

As shown in FIGS. 4, 5, 8, 9, 17, and 18, the floorboard frame 232 is removably coupled to the adapter assembly 210. As shown in FIGS. 4, 5, 8, 9, and 17, the floorboard frame 232 includes a plurality of longitudinal frame members (e.g., shafts, tubes, rails, etc.), shown as first frame rail 234, second frame rail 240, and third frame rail 242. As shown in FIGS. 8 and 9, the floorboard frame 232 includes a plurality of lateral frame members (e.g., shafts, tubes, rails, etc.), shown as fourth frame rail 244 and fifth frame rail 246, extending across the first frame rail 234, the second frame rail 240, and/or the third frame rail 242. In some embodiments, the frame members of the floorboard frame 232 are made from a metallic material, such as aluminum or steel. As shown in FIGS. 3-5, 8, 9, 11, 12, 15, and 17, the floorboard frame 232 includes one or more coupling members, shown as first bracket 250 and second bracket 252, positioned at ends of the second frame rail 240 and the third frame rail 242.

As shown in FIGS. 4, 5, 8, 9, and 17, the first frame rail 234 extends in a longitudinal direction from a first longitudinal side of the floorboard frame 232 (e.g., a front side) towards a second longitudinal side of the floorboard frame 232 (e.g., the rear side). As shown in FIGS. 4 and 8, the first frame rail 234 is positioned below the bumper 22 and is or is approximately laterally centered with respect to the body 20 and the floorboard frame 232. As shown in FIGS. 4 and 9, the first frame rail 234 defines a second aperture, shown as aperture 236, that is positioned to align with the aperture 214 of the adapter bracket 212. As shown in FIGS. 4, 8, and 9, the first frame rail 234 is coupled to and extends forward from the fourth frame rail 244.

As shown in FIGS. 4, 9, 11, 12, 15, and 17, the vehicle 10 includes a fastener (e.g., a bolt, a pin, etc.), shown as pin 238. The pin 238 is selectively insertable through the aperture 214 and the aperture 236 such that, when the pin 238 is positioned through the aperture 214 and the aperture 236, the floorboard assembly 230 is secured to the adapter bracket 212.

As shown in FIGS. 4, 5, 8, 9, and 17, the second frame rail 240 extends in a longitudinal direction, from the first longitudinal side of the floorboard frame 232 (e.g., the front side) to the second longitudinal side of the floorboard frame 232 (e.g., the rear side). The second frame rail 240 is substantially parallel to the first frame rail 234. The second frame rail 240 is laterally spaced from the first frame rail 234. As shown in FIGS. 4, 8, and 9, the second frame rail 240 is coupled to, extends between, and extends forward and rearward of the fourth frame rail 244 and the fifth frame rail 246. In some embodiments, the second frame rail 240 defines a pair of interface or notches that receive the fourth frame rail 244 and the fifth frame rail 246. As shown in FIGS. 4 and 8, the second frame rail 240 is positioned below the bumper 22 and is positioned proximate the first side of the adapter bracket 212. As shown in FIGS. 4, 5, and 8, at least a portion of the second frame rail 240 is selectively received by the first tube 216. That is, the first tube 216 is configured to selectively receive at least a portion of the second frame rail 240. When the second frame rail 240 is received by the first tube 216, at least a portion of the second frame rail 240 extends through the first tube opening 217. Additionally, when the first bushing 220 is positioned within the first tube 216, at least a portion of the second frame rail 240 extends through the first bushing opening 221. By way of example, the second frame rail 240 may be removably coupled to the first bushing 220 in an interference fit arrangement. When the portion of the second frame rail 240 extends through the first bushing opening 221, the first bushing 220 is positioned between the first tube 216 and the second frame rail 240, such that the first bushing 220 prevents the second frame rail 240 from contacting the first tube 216. For example, the first bushing 220 may substantially prevent metal to metal contact between the second frame rail 240 and the first tube 216. By preventing the metal to metal contact between the second frame rail 240 and the first tube 216, the first bushing 220 may mitigate vibration, noise, paint removal/surface damage, and/or corrosion that would be caused by the metal to metal contact.

When the second frame rail 240 is slid into and/or out of the first bushing 220, the material of the first bushing 220 (e.g., the plastic material) impregnates the material of the second frame rail 240 (e.g., the metallic material). Over time, the material of the first bushing 220 may further impregnate the material of the second frame rail 240, due to, for example, repeated insertion and extraction of the second frame rail 240 into/from the first bushing 220.

The impregnation of the plastic material onto the metallic material may reduce the frictional forces between the first bushing 220 and the second frame rail 240, thereby reducing the force required to insert or remove the second frame rail 240 into/from the first bushing 220.

As shown in FIGS. 4, 5, 8, 9, and 17, the third frame rail 242 extends in a longitudinal direction, from the first longitudinal side of the floorboard frame 232 (e.g., the front side) to the second longitudinal side of the floorboard frame 232 (e.g., the rear side). The third frame rail 242 is substantially parallel to the first frame rail 234 and/or the second frame rail 240. The third frame rail 242 is laterally spaced from the first frame rail 234 and the second frame rail 240. As shown in FIGS. 4, 8, and 9, the third frame rail 242 is coupled to, extends between, and extends forward and rearward of the fourth frame rail 244 and the fifth frame rail 246. In some embodiments, the third frame rail 242 defines a pair of interface or notches that receive the fourth frame rail 244 and the fifth frame rail 246. As shown in FIGS. 4 and 8, the third frame rail 242 is positioned below the bumper 22 and is positioned proximate the second side of the adapter bracket 212. As shown in FIGS. 4, 5, and 8, at least a portion of the third frame rail 242 is selectively received by the second tube 218. That is, the second tube 218 is configured to selectively receive at least a portion of the third frame rail 242. When the third frame rail 242 is received by the second tube 218, at least a portion of the third frame rail 242 extends through the second tube opening 219. Additionally, when the second bushing 222 is positioned within the second tube 218, at least a portion of the third frame rail 242 extends through the second bushing opening 223. By way of example, the third frame rail 242 may be removably coupled to the second bushing 222 in an interference fit arrangement. When the portion of the third frame rail 242 extends through the second bushing opening 223, the second bushing 222 is positioned between the second tube 218 and the third frame rail 242, such that the second bushing 222 prevents the third frame rail 242 from contacting the second tube 218. For example, the second bushing 222 substantially prevents metal to metal contact between the third frame rail 242 and the second tube 218. By preventing the metal to metal contact between the third frame rail 242 and the second tube 218, the second bushing 222 may mitigate vibration, noise, paint removal/surface damage, and/or corrosion that would be caused by the metal to metal contact.

When the third frame rail 242 is slid into and/or out of the second bushing 222, the material of the second bushing 222 (e.g., the plastic material) impregnates the material of the third frame rail 242 (e.g., the metallic material). Over time, the material of the second bushing 222 may further impregnate the material of the third frame rail 242, due to, for example, repeated insertion and extraction of the third frame rail 242 into/from the second bushing 222. The impregnation of the plastic material onto the metallic material may reduce the frictional forces between the second bushing 222 and the third frame rail 242, thereby reducing the force required to insert or remove the third frame rail 242 into/from the second bushing 222.

As shown in FIGS. 8 and 9, the fourth frame rail 244 extends in a lateral direction from a first lateral side of the floorboard frame 232 to a second lateral side of the floorboard frame 232 across the second frame rail 240 and the third frame rail 242. In some embodiments, the fourth frame rail 242 defines a pair of interface or notches that receive the second frame rail 240 and the third frame rail 242. As shown in FIGS. 8 and 9, the fourth frame rail 244 is substantially perpendicular to the first frame rail 234, the second frame rail 240, and/or the third frame rail 242. As shown in FIG. 9, the fourth frame rail 244 is positioned longitudinally rearward and spaced away from the adapter bracket 212. As shown in FIG. 8, the fourth frame rail 244 is positioned below the bumper 22. The fourth frame rail 244 is coupled (e.g., welded, fastened, etc.) to the first frame rail 234, the second frame rail 240, and the third frame rail 242. As shown in FIGS. 8 and 9, the fourth frame rail 244 defines one or more apertures, shown as platform apertures 245. Each of the platform apertures 245 is configured to receive a corresponding fastener 248. The fastener 248 is configured to facilitate securing the floor board body 256 to the fourth frame rail 244.

As shown in FIGS. 8 and 9, the fifth frame rail 246 extends in a lateral direction from a first lateral side of the floorboard frame 232 to a second lateral side of the floorboard frame 232 across the second frame rail 240 and the third frame rail 242. In some embodiments, the fourth frame rail 242 defines a pair of interface or notches that receive the second frame rail 240 and the third frame rail 242. As shown in FIGS. 8 and 9, the fifth frame rail 246 is substantially parallel to the fourth frame rail 244 and is substantially perpendicular to the first frame rail 234, the second frame rail 240, and/or the third frame rail 242. As shown in FIG. 9, the fifth frame rail 246 is positioned longitudinally rearward and spaced away from the fourth frame rail 244. As shown in FIG. 8, the fifth frame rail 246 is positioned below the bumper 22. The fifth frame rail 246 is coupled (e.g., welded, fastened, etc.) to the second frame rail 240 and the third frame rail 242. As shown in FIGS. 8 and 9, the fifth frame rail 246 defines one or more apertures, shown as platform apertures 247. Each of the platform apertures 247 is configured to receive a corresponding fastener 248. The fastener 248 is configured to facilitate securing the floorboard body 256 to the fifth frame rail 246.

As shown in FIGS. 8 and 9, the first bracket 250 is couped to the second frame rail 240 proximate the second end of the floorboard frame 232. The first bracket 250 extends longitudinally rearward from the second frame rail 240, and at least a portion of the first bracket 250 extends vertically above the second frame rail 240. As shown in FIGS. 3-5, 8, 9, 11, and 12, the first bracket 250 defines one or more apertures, shown as first bracket aperture 251. As shown in FIGS. 15-17, the first bracket aperture 251 is sized to receive a fastener (e.g., a pin, a bolt, etc.), shown as fastener 254. The fastener 254 is selectively positionable within the first bracket aperture 251. As described below, the fastener 254 is configured to couple the guard 300 to the floorboard frame 232 when the fastener 254 is positioned within the first bracket aperture 251.

As shown in FIGS. 8 and 9, the second bracket 252 is couped to the third frame rail 242 proximate the second end of the floorboard frame 232. The second bracket 252 extends longitudinally rearward from the third frame rail 242, and at least a portion of the second bracket 252 extends vertically above the third frame rail 242. As shown in FIGS. 3-5, 8, 9, 11, and 12, the second bracket 252 defines one or more apertures, shown as second bracket aperture 253. As shown in FIG. 17, the second bracket aperture 253 is sized to receive the fastener 254. The fastener 254 is selectively positionable within the second bracket aperture 253. As described below, the fastener 254 is configured to couple the guard 300 to the floorboard frame 232 when the fastener 254 is positioned within the second bracket aperture 253.

As shown in FIG. 4, the floorboard body 256 is coupled to the floorboard frame 232. In particular, the floorboard body 256 is coupled to a top surface of the floorboard frame 232, such that the floorboard body 256 is positioned above the floorboard frame 232. As shown in FIGS. 3-5, 11, 12, and 15-17, the floorboard body 256 includes a horizontal portion, shown as deck portion 257, and a vertical portion, shown as skirt portion 258. The deck portion 257 extends substantially horizontally, above the floorboard frame 232 and rearward from the body 20. The deck portion 257 may support the feet of an occupant as the occupant steps into the vehicle 10 (e.g., to enter or exit the rear-facing seat assembly 200). The skirt portion 258 extends substantially vertically, downward from the deck portion 257, towards the floorboard frame 232. The skirt portion 258 at least partially covers the floorboard frame 232, such that the floorboard frame 232 is at least partially visually obscured from of an occupant of the vehicle 10.

As shown in FIGS. 3, 13, 14, and 18, the rear-facing seat assembly 200 includes a seat portion, shown as seat 267 (e.g., a second seat, a rear-facing seat, a seat bottom, etc.), and a second seat portion, shown as backrest 268 (e.g., a second backrest, rear-facing backrest, etc.). The seat 267 extends substantially horizontally and supports the bottom of the occupant. The backrest 268 extends substantially vertically and supports the back of the occupant.

As shown in FIGS. 3-5, 8, 13, and 14, the seat assembly 260 is coupled to the adapter assembly 210. The seat assembly 260 is positioned above the bumper 22 and at least partially forward of the floorboard assembly 230. As shown in FIGS. 3-5, 8, 13, 14, and 18, the seat assembly 260 includes a first portion, shown as seat frame 262, and a second portion, shown as seat body 264. As shown in FIGS. 3, 4, 5, 7, 8, 11, and 12, the seat assembly 260 includes one or more elongated members (e.g., a column, a pillar, arms, etc.), shown as support 270. In some embodiments, the seat 267 and the backrest 268 are part of the seat assembly 260.

As shown in FIGS. 3-5, and 8, the seat frame 262 is coupled to the frame 12 and/or the body 20 of the vehicle 10. As shown in FIGS. 3-5, 8, 11 and 12, the seat frame 262 is coupled to the adapter assembly 210 (e.g., via the support 270). The seat frame 262 is positioned proximate a rear side of the vehicle 10 and at least partially forward of the bumper 22. The seat frame 262 extends between the right side of the body 20 (e.g., the first lateral side) to the left side of the body 20 (e.g., the second lateral side). At least a portion of the seat frame 262 is positioned within the equipment storage area 24.

As shown in FIGS. 11, 12, and 14, the seat frame 262 includes a movable member or pivotable coupler, shown as hinge 263. As shown in FIGS. 11 and 12, the hinge 263 is positioned at a first lateral side and/or a second lateral side of the seat frame 262. As shown in FIG. 14, the hinge 263 is positioned at a rear side of the seat frame 262 and extends in the lateral direction across at least a portion of the seat frame 262. In either case, the hinge 263 movably couples the seat frame 262 to the seat body 264. The hinge 263 defines an axis of rotation that extends laterally. The seat body 264 rotates relative to the seat frame 262 about the axis of rotation defined by the hinge 263.

As shown in FIGS. 3-5, 8, 13, and 14, the seat body 264 is pivotably coupled to the seat frame 262. The seat body 264 extends between the right side of the body 20 (e.g., the first lateral side) to the left side of the body 20 (e.g., the second lateral side). The seat body 264 is selectively positionable between a first position (e.g., a seating position or a seating configuration), shown in FIGS. 3-5, 8, 11, 13, and 18, and a second position (e.g., a cargo storage position or a cargo storage configuration), shown in FIGS. 12 and 14. When the seat body 264 is in the first position, the seat body 264 is positioned above the seat frame 262. When the seat body 264 is in the second position, the seat body 264 is positioned rearward of the seat frame 262 and above the floorboard assembly 230 (when the floorboard assembly 230 is coupled to the adapter assembly 210).

As shown in FIGS. 12, 14, 21, and 22, the seat body 264 defines one or more cavities, shown as first notch 265 and second notch 266. The first notch 265 is positioned at rear end of the seat body 264 (but closer to a front end of the vehicle 10) and proximate a first side of the seat body 264. The second notch 266 is positioned at the rear end of the seat body 264 and proximate a second side of the seat body 264, opposite the first side.

As shown in FIGS. 11 and 12, the seat assembly 260 includes a support member, shown as backrest frame 272. The backrest frame 272 is coupled to the seat frame 262 and is positioned forward of the seat body 264. The backrest frame 272 is configured to facilitate coupling the backrest 268 to the seat assembly 260.

As shown in FIGS. 3, 11-14, and 18, the seat assembly 260 includes one or more arm rests, shown as arm rests 269 (e.g., a first arm rest and a second arm rest). The arm rest 269 is coupled to the seat frame 262 and is positioned at a lateral side (e.g., a first lateral side and/or a second lateral side) of the seat frame 262 and/or the seat body 264.

As shown in FIGS. 3-5, 7, 8, 11, and 12, the support 270 extends between the adapter assembly 210 and the seat frame 262 to at least partially support the seat frame 262. The support 270 is positioned forward from the bumper 22 and at least partially within the equipment storage area 24. In some embodiments, the support 270 couples the seat frame 262 to the adapter assembly 210. As shown in FIGS. 3-5, 7, and 8, the support 270 is coupled to the adapter bracket 212 at or closer to a first side of the adapter bracket 212 (e.g., proximate the first tube 216). As shown in FIGS. 11 and 12, the seat assembly 260 includes a second support 270 that is laterally spaced from the first support 270. The second support 270 extends between the adapter assembly 210 and the seat frame 262 to at least partially support the seat frame 262. As shown in FIGS. 11 and 12, the aperture 214 is positioned between the first support 270 and the second support 270.

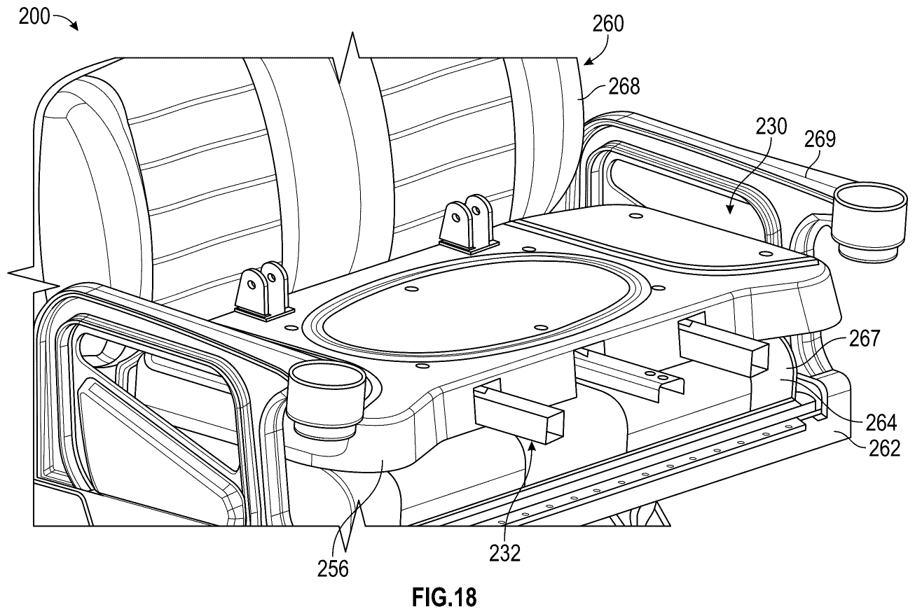

In some embodiments, when the floorboard assembly 230 is decoupled from the adapter assembly 210, the floorboard assembly 230 may be temporarily stored away from the vehicle 10 or on top of the seat assembly 260. As shown in FIG. 18, the floorboard assembly 230 is positioned on top of the seat assembly 260. More specifically, the floorboard assembly 230 assembly is positioned on top of the seat body 264.

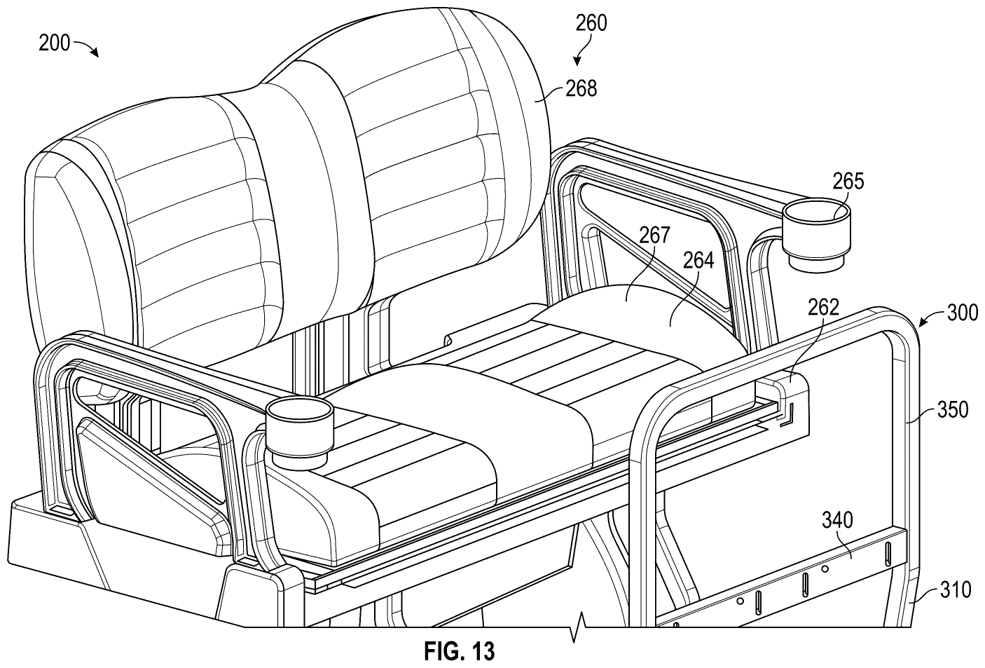

As shown in FIGS. 13 and 14, the guard 300 is positioned rearward of the seat assembly 260. As shown in FIGS. 15-17, the guard 300 is positioned rearward of the bumper 22, and the guard 300 extends above the floorboard assembly 230. As shown in FIGS. 15 and 16, the guard 300 is coupled to the floorboard assembly 230.

As shown in FIGS. 15-17, the guard 300 includes a guard body, shown as guard rail 302. The guard rail 302 defines one or more apertures, shown as apertures 304, positioned to align with the first bracket aperture 251 and the second bracket aperture 253. The fastener 254 is selectively insertable through the first bracket aperture 251 and the aperture 304 such that, when the fastener 254 is positioned through the first bracket aperture 251 and the aperture 304, the fastener 254 couples the guard 300 to the first bracket 250. The fastener 254 is selectively insertable through the second bracket aperture 253 and the aperture 304 such that, when the fastener 254 is positioned through the second bracket aperture 253 and the aperture 304, the fastener 254 couples the guard 300 to the second bracket 252.

As shown in FIGS. 13,14, and 19-22, the guard rail 302 of the guard 300 includes a first portion, shown as lower guard portion 310, a second portion, shown as upper guard portion 350, and a third portion, shown as cross bar 340. In some embodiments, the guard rail 302 does not include the cross bar 340. In some embodiments, the lower guard portion 310 and the upper guard portion 350 form a unitary structure. In some embodiments, the lower guard portion 310 and the upper guard portion 350 are detachably from one another or pivotable relative to one another.

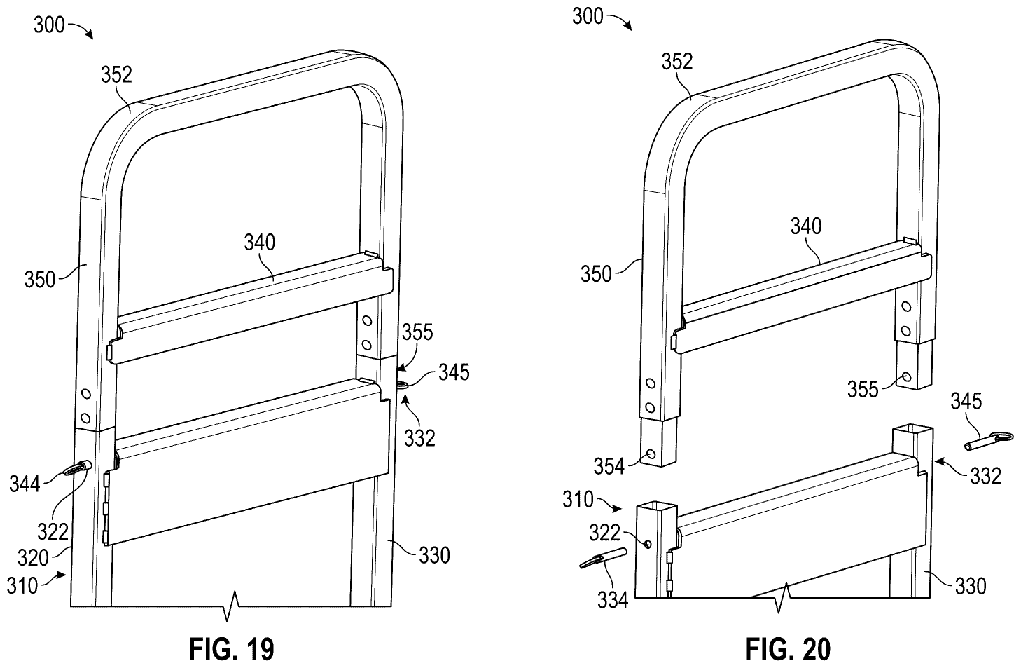

As shown in FIGS. 19-22, the lower guard portion 310 includes a first portion, shown as first lower guard rail 320, and a second portion, shown as second lower guard rail 330. In some embodiments, one or both of the first lower guard rail 320 or the second lower guard rail 330 defines the at least one aperture 304, described above.

As shown in FIGS. 19 and 20, the first lower guard rail 320 defines an aperture 322. The aperture 322 is positioned at or proximate first end (e.g., a top end) of the first lower guard rail 320, opposite the aperture 304. The aperture 322 is defined laterally through the first lower guard rail 320. The aperture 322 is sized to receive a fastener, shown as pin 344, as described below.

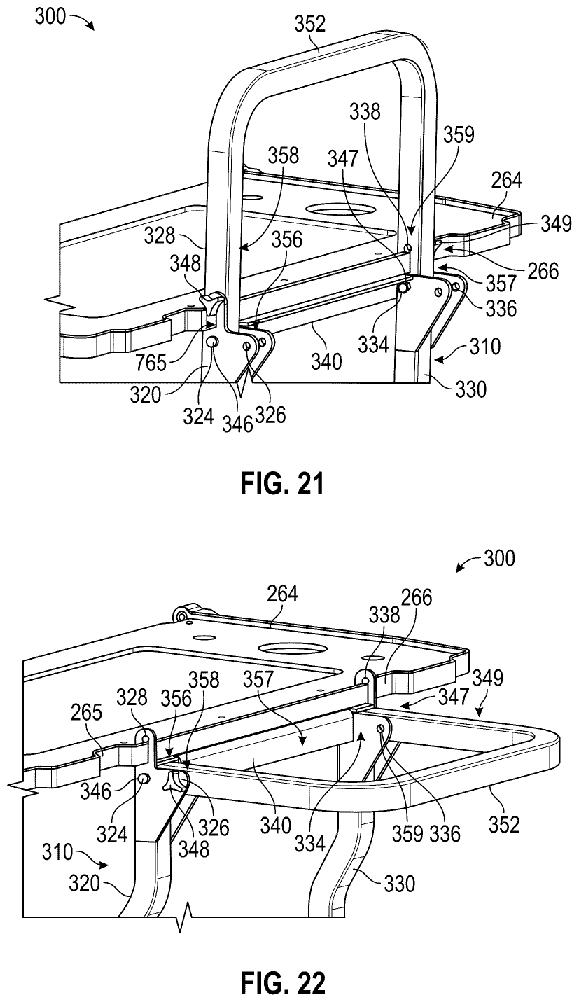

As shown in FIGS. 21 and 22, the first lower guard rail 320 additionally or alternatively defines one or more apertures, shown as first lower guard first aperture 324, first lower guard second aperture 326, and- first lower guard slot 328. The first lower guard first aperture 324 is positioned at or proximate a first end (e.g., a top end) of the first lower guard rail 320, opposite the aperture 304. The first lower guard first aperture 324 is defined laterally through the first lower guard rail 320. The first lower guard first aperture 324 is sized to receive a fastener, shown as pin 346, as described below. The first lower guard second aperture 326 is positioned at or proximate the first end (e.g., a top end) of the first lower guard rail 320, opposite the aperture 304, and longitudinally rearward from the first lower guard first aperture 324. The first lower guard second aperture 326 is defined laterally through the first lower guard rail 320. The first lower guard second aperture 326 is sized to receive a fastener, shown as hand fastener 348, as described below. The first lower guard slot 328 is positioned at or proximate first end (e.g., a top end) of the first lower guard rail 320, opposite the aperture 304, and above the first lower guard first aperture 324. The first lower guard slot 328 is defined laterally through the first lower guard rail 320. The first lower guard slot 328 is sized to receive the hand fastener 348, as described below.

As shown in FIG. 20, the second lower guard rail 330 defines an aperture 332. The aperture 332 is positioned at or proximate a first end (e.g., a top end) of the second lower guard rail 330, opposite the aperture 304. The aperture 332 is defined laterally through the second lower guard rail 330. The aperture 332 is sized to receive a fastener, shown as pin 345, as described below.

As shown in FIGS. 21 and 22, the second lower guard rail 330 additionally or alternatives defines one or more apertures, shown as second lower guard first aperture 334, second lower guard second aperture 336, and second lower guard slot 338. The second lower guard first aperture 334 is positioned at or proximate a first end (e.g., a top end) of the second lower guard rail 330, opposite the aperture 304. The second lower guard first aperture 334 is defined laterally through the second lower guard rail 330. The second lower guard first aperture 334 is sized to receive a fastener, shown as pin 347, as described below. The second lower guard second aperture 336 is positioned at or proximate the first end (e.g., a top end) of the second lower guard rail 330, opposite the aperture 304, and longitudinally rearward from the second lower guard first aperture 334. The second lower guard second aperture 336 is defined laterally through the second lower guard rail 330. The second lower guard second aperture 336 is sized to receive a fastener, shown as hand fastener 349, as described below. The second lower guard slot 338 is positioned at or proximate the first end (e.g., a top end) of the second lower guard rail 330, opposite the aperture 304, and above the second lower guard first aperture 334. The second lower guard slot 338 is defined laterally through the second lower guard rail 330. The second lower guard slot 338 is sized to receive the hand fastener 349, as described below.

As shown in FIGS. 19-22, the upper guard portion 350 includes a main portion, shown as upper guard rail 352 (e.g., a u-shaped rail). portion 350 portion 350 As shown in FIGS. 19 and 20, the upper guard rail 352 defines a plurality of apertures, shown as upper guard member first aperture 354 and upper guard member second aperture 355. The upper guard member first aperture 354 is positioned to align with the aperture 322 of the first lower guard rail 320. The upper guard member first aperture 354 is defined laterally through the upper guard rail 352. The upper guard member first aperture 354 is sized to receive the pin 344. The pin 344 is selectively insertable through the aperture 322 and the upper guard member first aperture 354 such that, when the pin 344 is positioned through the aperture 322 and the upper guard member first aperture 354, the upper guard portion 350 is secured to the lower guard portion 310, or, more specifically, to the first lower guard rail 320. The upper guard member second aperture 355 is positioned to align with the aperture 332 of the second lower guard rail 330. The upper guard member second aperture 355 is defined laterally through the upper guard rail 352. The upper guard member second aperture 355 is sized to receive the pin 345. The pin 345 is selectively insertable through the aperture 332 and the upper guard member second aperture 355 such that, when the pin 345 is positioned through the aperture 332 and the upper guard member second aperture 355, the upper guard portion 350 is secured to the lower guard portion 310, or, more specifically, to the second lower guard rail 330. As shown in FIG. 20, removing the pin 344 and the pin 355 facilitates detaching the upper guard rail 352 from the first lower guard rail 320 and the second lower guard rail 330.

As shown in FIGS. 21 and 22, the upper guard rail 352 defines a plurality of apertures, shown as upper guard member first aperture 356, an upper guard member second aperture 357, an upper guard member third aperture 358, and an upper guard member fourth aperture 359. The upper guard member first aperture 356 is positioned to align with the first lower guard first aperture 324. The upper guard member first aperture 356 is defined laterally through the upper guard rail 352. The upper guard member first aperture 356 is sized to receive the pin 346. The pin 346 is selectively insertable through the first lower guard first aperture 324 and the upper guard member first aperture 356 such that, when the pin 346 is positioned through the first lower guard first aperture 324 and the upper guard member first aperture 356, the upper guard portion 350 is secured to the lower guard portion 310, or, more specifically, to the first lower guard rail 320. The upper guard member second aperture 357 is positioned to align with the second lower guard first aperture 334. The upper guard member second aperture 357 is defined laterally through the upper guard rail 352. The upper guard member second aperture 357 is sized to receive the pin 347. The pin 347 is selectively insertable through the second lower guard first aperture 334 and the upper guard member second aperture 357 such that, when the pin 347 is positioned through the second lower guard first aperture 334 and the upper guard member second aperture 357, the upper guard portion 350 is secured to the lower guard portion 310, or, more specifically, to the second lower guard rail 330.

As shown in FIGS. 21 and 22, the upper guard portion 350 is pivotably coupled to the lower guard portion 310. In particular, the upper guard portion 350 rotates relative to the lower guard portion 310 about an axis of rotation that extends laterally and is defined by at least one of the first lower guard first aperture 324, the pin 346, the upper guard member first aperture 356, the second lower guard first aperture 334, the pin 347, and/or the upper guard member second aperture 357. That is the first lower guard first aperture 324, the pin 346, the upper guard member first aperture 356, the second lower guard first aperture 334, the pin 347, and/or the upper guard member second aperture 357 are centered on the axis of rotation. The upper guard portion 350 is shown in a first guard configuration (e.g., a deployed configuration, a first guard position, etc.) in FIG. 21, where the upper guard portion 350 extends in a substantially vertical direction. When the upper guard portion 350 is in the first guard configuration and when the seat body 264 is in the cargo storage configuration, the upper guard portion 350 may be used to facilitate securing cargo on or proximate the seat body 264. Further, the upper guard rail 352 may engage with the first notch 265 and the second notch 266 when the upper guard portion 350 is in the first guard configuration and when the seat body 264 is in the cargo storage configuration. When the upper guard portion 350 is in the first guard configuration and when the seat body 264 is in the seating configuration, the upper guard portion 350 may be used to assist ingress and egress of a passenger into or out of the rear row seating 34. The upper guard portion 350 is shown in a second guard configuration (e.g., a retracted configuration, a second guard position, etc.) in FIG. 22, where the upper guard portion 350 extends in a substantially horizontal direction. When the upper guard portion 350 is in the second guard configuration and when the seat body 264 is in the cargo storage configuration, the upper guard portion 350 is positioned below the seat body 264 to facilitate loading and/or unloading of cargo on or proximate the seat body 264.

As shown in FIG. 21, when the upper guard portion 350 is in the first guard configuration, the upper guard member third aperture 358 is positioned to align with the first lower guard slot 328. The upper guard member third aperture 358 is defined laterally through the upper guard rail 352. The upper guard member third aperture 358 is sized to receive the hand fastener 348. The hand fastener 348 is selectively insertable through the first lower guard slot 328 and the upper guard member third aperture 358 such that, when the hand fastener 348 is positioned through the first lower guard slot 328 and the upper guard member third aperture 358, the upper guard portion 350 is secured to the lower guard portion 310, or, more specifically, to the first lower guard rail 320, in the first guard configuration.

As shown in FIG. 22, when the upper guard portion 350 is in the second guard configuration, the upper guard member third aperture 358 is positioned to align with the first lower guard second aperture 326. The hand fastener 348 is selectively insertable through the first lower guard second aperture 326 and the upper guard member third aperture 358 such that, when the hand fastener 348 is positioned through the first lower guard second aperture 326 and the upper guard member third aperture 358, the upper guard portion 350 is secured to the lower guard portion 310, or, more specifically, to the first lower guard rail 320, in the second guard configuration.

As shown in FIG. 21, when the upper guard portion 350 is in the first configuration, the upper guard member fourth aperture 359 is positioned to align with the second lower guard slot 338. The upper guard member fourth aperture 359 is defined laterally through the upper guard rail 352. The upper guard member fourth aperture 359 is sized to receive the hand fastener 349. The hand fastener 349 is selectively insertable through the second lower guard slot 338 and the upper guard member fourth aperture 359 such that, when the hand fastener 349 is positioned through the second lower guard slot 338 and the upper guard member fourth aperture 359, the upper guard portion 350 is secured to the lower guard portion 310, or, more specifically, to the second lower guard rail 330, in the first guard configuration.

As shown in FIG. 22, when the upper guard portion 350 is in the first configuration, the upper guard member fourth aperture 359 is positioned to align with the second lower guard second aperture 336. The hand fastener 349 is selectively insertable through the second lower guard second aperture 336 and the upper guard member fourth aperture 359 such that, when the hand fastener 349 is positioned through the second lower guard second aperture 336 and the upper guard member fourth aperture 359, the upper guard portion 350 is secured to the lower guard portion 310, or, more specifically, to the second lower guard rail 330, in the second guard configuration.

As shown in FIGS. 19 and 20, the cross bar 340 is coupled to the upper guard portion 350. In particular, the cross bar 340 extends across the upper guard rail 352. The cross bar 340 is configured to at least partially support the seat body 264, when the seat body 264 is in the cargo storage configuration.

As shown in FIGS. 21 and 22, the cross bar 340 is coupled to the lower guard portion 310. In particular, the cross bar 340 extends between the first lower guard rail 320 and the second lower guard rail 330. The cross bar 340 is coupled to the first lower guard rail 320 and the second lower guard rail 330, proximate the first lower guard first aperture 324 and the second lower guard first aperture 334, respectively. The cross bar 340 is configured to at least partially support the seat body 264, when the seat body 264 is in the cargo storage configuration.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) as shown in the various exemplary embodiments is illustrative only. Additionally, any element disclosed in one embodiment may be incorporated or utilized with any other embodiment disclosed herein.

1. A golf vehicle comprising:
a vehicle frame;
an adapter assembly coupled to the vehicle frame, the adapter assembly including:
an adapter bracket defining a first aperture; and
a tube coupled to the adapter bracket;
a floorboard assembly including a floorboard frame removably coupled to the adapter assembly, the floorboard frame including:
a first frame rail defining a second aperture positioned to align with the first aperture; and
a second frame rail selectively received by the tube; and
a pin selectively insertable through the first aperture and the second aperture such that, when the pin is positioned through the first aperture and the second aperture, the floorboard assembly is secured to the adapter bracket.

2. The golf vehicle of claim 1, wherein:
the adapter assembly includes a bushing positioned within the tube;
the bushing defines a bushing opening; and
the second frame rail extends through the bushing opening.

3. The golf vehicle of claim 2, wherein:
the bushing is a linear bushing comprising a first material;
the second frame rail comprises a second material different from the first material; and
the first material impregnates the second material as the second frame rail is slid into and out of the bushing.

4. The golf vehicle of claim 1, wherein the floorboard assembly includes:
a bracket coupled to the second frame rail, the bracket defining a third aperture;
a guard defining a fourth aperture positioned to align with the third aperture; and
a fastener selectively insertable through the third aperture and the fourth aperture such that, when the fastener is positioned through the third aperture and the fourth aperture, the fastener couples the guard to the bracket.

5. The golf vehicle of claim 1, wherein:
the tube is a first tube;
the adapter assembly includes a second tube laterally spaced from the first tube and coupled to the adapter bracket; and
the floorboard assembly includes a third frame rail laterally spaced from the second frame rail and selectively received by the second tube.

6. The golf vehicle of claim 1, further comprising a bumper, wherein the adapter assembly is coupled to the vehicle frame such that the adapter assembly is positioned below the bumper.

7. The golf vehicle of claim 6, wherein, when coupled to the adapter assembly, the floorboard assembly is at least partially positioned below the bumper.

8. The golf vehicle of claim 6, further comprising a seat assembly positioned above the bumper and at least partially forward of the floorboard assembly.

9. The golf vehicle of claim 8, wherein the seat assembly includes:
a seat frame;
a seat body pivotably coupled to the seat frame; and
a support extending between the adapter assembly and the seat frame to at least partially support the seat frame.

10. The golf vehicle of claim 9, wherein the support is coupled to the adapter bracket at a first side of the adapter bracket, wherein the tube is coupled to the adapter bracket at the first side.

11. A golf vehicle comprising:
a vehicle frame;
a bumper coupled to the vehicle frame;
an adapter assembly coupled to the vehicle frame and positioned below the bumper; and
a seat assembly positioned above the bumper, the seat assembly including:
a seat frame,
a support coupled to the adapter assembly and positioned forward from the bumper, and
a seat body pivotably coupled to the seat frame and configured to rotate relative to the seat frame about an axis of rotation that extends laterally.

12. The golf vehicle of claim 11, wherein the seat body is configured to rotate relative to the seat frame between:
a first seat body position where the seat body is configured to support a passenger; and
a second seat body position, where the seat body is configured to support cargo.

13. The golf vehicle of claim 11, wherein:
the adapter assembly includes an adapter bracket, the adapter bracket defining a first aperture;
the golf vehicle includes a floorboard assembly having a floorboard frame removably coupled to the adapter assembly, the floorboard frame defining a second aperture positioned to align with the first aperture; and
the golf vehicle includes a pin selectively insertable through the first aperture and the second aperture such that, when the pin is positioned through the first aperture and the second aperture, the floorboard assembly is secured to the adapter bracket.

14. The golf vehicle of claim 13, wherein:
the adapter assembly further comprises a tube defining a tube opening; and
the floorboard frame comprises a frame rail extending through the tube opening, such that a frame rail first portion of the frame rail is positioned within the tube.

15. The golf vehicle of claim 14, wherein:
the golf vehicle includes a bushing positioned within the tube;
the bushing defines a bushing opening; and
the busing is configured to selectively receive the frame rail within the bushing opening.

16. The golf vehicle of claim 15, wherein:
the bushing is a linear bushing comprising a first material;
the frame rail comprises a second material different from the first material; and
the first material impregnates the second material as the frame rail is slid into and out of the bushing.

17. A rear-facing seat assembly for a golf vehicle, the rear-facing seat assembly comprising:
an adapter assembly including an adapter bracket defining a first aperture;
a floorboard assembly including a floorboard frame having a frame rail defining a second aperture positioned to align with the first aperture;
a pin selectively insertable through the first aperture and the second aperture such that, when the pin is positioned through the first aperture and the second aperture, the floorboard assembly is secured to the adapter assembly;
a seat assembly including:
a seat frame positioned above the adapter assembly;
a seat body coupled to the seat frame; and
a support extending between the adapter assembly and the seat frame to at least partially support the seat frame.

18. The rear-facing seat assembly of claim 17, wherein:
the adapter assembly includes a tube coupled to the adapter bracket;
the frame rail is a first frame rail; and
the floorboard frame includes a second frame rail selectively received by the tube.

19. The rear-facing seat assembly of claim 17, wherein:
the support is a first support;
the rear-facing seat assembly includes a second support laterally spaced from the first support, the second support extending between the adapter assembly and the seat frame to at least partially support the seat frame; and
the first aperture is positioned between the first support and the second support.

20. The rear-facing seat assembly of claim 17, the rear-facing seat assembly includes:
a backrest frame coupled to the seat frame and positioned forward of the seat body, the backrest frame configured to enable coupling a backrest to the rear-facing seat assembly; and
an armrest coupled to the seat frame and positioned at a lateral side of the seat body.
